(19) United States
(12) Patent Application Publication
(10) Pub. No.: US 2016/0205956 A1
(43) Pub. Date: Jul. 21, 2016

(54) Filet slicing device

(71) Applicant: James Bryant, Roanoke Rapids, NC (US)

(72) Inventor: James Bryant, Roanoke Rapids, NC (US)

(21) Appl. No.: 14/988,741

(22) Filed: Jan. 5, 2016

Related U.S. Application Data
(60) Provisional application No. 62/099,609, filed on Jan. 5, 2015.

(51) Int. Cl. A22C 25/06

(52) U.S. Cl. CPC A22C 25/06

(57) ABSTRACT

A filet slicing device provides a top and bottom plate to secure the piece of meat, a holder, and a plurality of center plates of varying thicknesses which enable the user to cut filets of corresponding thicknesses. The top plate provides a window, enabling the user to observe the meat and monitoring the progress of the each cut. The holder may be pressed downward into the top window as necessary.

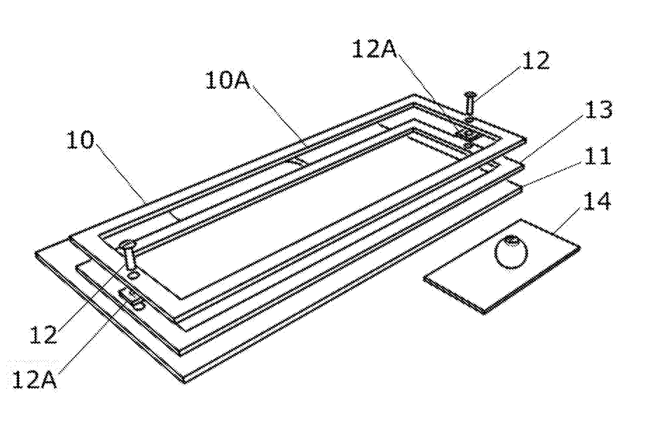

### CROSS-REFERENCE TO RELATED APPLICATIONS

This Application claims the benefit of U.S. Provisional Application No. 62/099,609, filed Jan. 5, 2015, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to kitchen devices and in particular to a filet slicing device. Thin-sliced filets of meat are usually offered for higher prices at the meat counter. Many chefs would prefer to do the filet slicing themselves. Saving the difference in price, and cutting the meat to the precise thickness desired, are two factors that make this an attractive option.

A search of the prior art reveals that the equipment used by butchers and meat packers for fileting is expensive and takes up a great deal of counter space. Additionally, it is often the case that filets are too thick and chunky to cook evenly. In some cases, a prior art invention is designed to filet only one species of fish, such as catfish, without accommodating other species of fish or types of meat, such as beef or ham. None of the prior art is closely related to the present invention, but several inventions include features which resemble those of the present invention. Each has proven to be less than satisfactory in its own way.

Apparatus designed for fileting of fish, U.S. Pat. No. 7,322,573 (priority Jan. 10, 2007), provides an apparatus which includes a retaining pan and a pair of support elements capable of spanning the width of the pan interior by attachment to the opposing outer edges of the pan. The support elements have retaining elements which are used to securely affix a cutting board to the support elements. Once assembled, the cutting board creates an ideal location to filet a fish while allowing the fluids discharged from the fish to flow over the edges of the board and collect into the surrounding retaining pan.

Process for fileting fish and machine for performing this process, U.S. Pat. No. 6,200,211 (priority Jun. 3, 1997), provides a fileting process for fish of the Siluridae species, for instance, catfish (Ictalurus punctatus). The bone plate present in the area of the dorsal fin of these species for supporting the dorsal spike is first undercut from the dorsal area without cutting through its connection to the bone structure, in order to obtain largely trim-free filets. This takes place by means of a cutting tool that makes incisions under the bone plate up to the ventral bones, so that, in the subsequent cutting free of the filet meat from the ventral bones, the outer parts of the bone plate accumulate separately from the filet meat.

Fish fileting knife, U.S. Pat. No. 4,592,113 (priority Jul. 31, 1984), provides a fish fileting apparatus comprising an elongated flat metal blade having a pair of cutting edges along each side of the blade, a handle which is offset from the blade, and a connecting portion which interconnects the blade and the handle. The connecting portion is inclined with respect to the blade and the handle such that the blade may rest uniformly on a surface while a user's hand is gripped around the handle.

Fish fillet knife, U.S. Pat. No. 4,920,612 (priority Jun. 5, 1989), provides a knife for filleting fish which includes a generally flat cutting blade that is disposed in a second plane and has a proximal end, a distal end and a cutting edge. The proximal end of the boning blade is positioned in a manner such that the first plane of the cutting blade are generally normal to one another. A handle is attached to the proximal end of the cutting blade, and the knife thereby permits cutting of a fish along either of two cutting axes without substantially changing the orientation of the knife with respect to the fish.

Process and assembly for defilleting fish, German Patent No. 19817840 (priority Jun. 3, 1997), provides a mechanical process to remove fish fillets from the headless cadaver of the Siluridae species e.g. Catfish (Ictalurus punctatus), and undercuts the bone plate (Os Exoccipitale) bearing the dorsal spine in the vicinity of dorsal fin while leaving the fillet attached to the skeleton. The fillet is then cut from the skeleton. Also claimed is a conveyer which moves headless fish in the direction of their longitudinal axis along a given conveyer path; appropriate cutters are located either side of the fish which liberate the fillet pieces, and sensors determine the individual fish size and are linked to the active parts of the machine and control the de-filleting process.

Apparatus for cutting fish body into three fillets, Japanese Patent No. H09289868 (priority Apr. 25, 1996), provides an apparatus which is composed of a transferring means, two pairs of main round rotary blades, and a pair of supplementary round rotary blades. The transferring means holds the center of the middle rib of a fish body by a pair of clamps from both sides of the direction crossing to the dorso-ventral direction and transfers the fish body in the longitudinal direction of the fish body. The two pairs of main round rotary blades are placed in the pathway where the fish body is transferred so that each of the pairs of round rotary blades has a space through which the middle rib of the transferred fish body can pass. The pairs of the main round rotary blades are placed at both sides of the position where the middle rib passes. Thus, the two pairs of the main round rotary blades cut the transferred fish body from both the dorsal side and the ventral side toward the vicinity of the middle rib. The pair of supplementary round rotary blades are placed on the downstream side of the transferring direction of the fish body from the position where the both pairs of the main round rotary blades are approaching to each other, and cuts and separates the middle rib from the fish body. Further, each pair of the main round rotary blades are placed so that blades are closed at the transferring pathway side of the fish and widened at the departing sides from the transferring pathway. The supplementary round rotary blades are placed in such a manner that they partly enter between the two pairs of the main round rotary blades but not interfere them, and intrude into the pathway of the fish body.

The present invention has been developed for the purpose of addressing and resolving these disadvantages. A filet slicing device, which inexpensively enables the user to cut a filet to a uniform desired thickness, may be easily stored in a drawer when not in use, and allows larger chunks of meat to be sliced into thinner and more even filets, would resolve these problems. Not only does this allow the meat to be cooked better and more evenly, it also allows for a better looking cut of fish when preparing a dish.

### SUMMARY OF THE INVENTION

Accordingly, the invention is directed to a filet slicing device. The device provides a top and bottom plate to secure the piece of meat, a holder, and a plurality of center plates of varying thicknesses which enable the user to cut filets of corresponding thicknesses. The top plate provides a window, enabling the user to observe the meat and monitoring the progress of the each cut. The holder may be pressed downward into the top window as necessary.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

The FIGURE shows a top perspective view of the first exemplary embodiment, displaying the top plate 10, the window 10A, the bottom plate 11, the screws 12, a center plate 13, and the holder 14.

### DETAILED DESCRIPTION OF THE INVENTION

Referring now to the invention in more detail, the invention is directed to a filet slicing device.

The first exemplary embodiment is preferably rectangular and provides a top plate 10 and a bottom plate 11 to secure the piece of meat, a holder 14, and a plurality of center plates 13 of varying thicknesses which enable the user to cut filets of corresponding thicknesses. Preferably, three center plates 13 are provided in thicknesses of 0.25 inch, 0.375 inch, and 0.5 inch. More or fewer center plates 13, with different thicknesses, are contemplated. Overall thickness of the top plate 10 and the bottom plate 11 combined is 0.25 inch. Preferably, the overall dimensions of the filet is 10 inches in width, 4 inches in length, and 0.25 inches thick.

The top plate 10, a center plate 13 selected by the user, and the bottom plate 11 are secured together with a plurality of screws 12 which may be tightened and loosened by hand. A washer 12A for each screw 12 is preferably provided beneath the top plate 10 to provide space for the thickness of the knife blade. Each washer 12A is preferably 0.0625 inch in thickness. The top plate 10 provides a window 10A, enabling the user to observe the meat and monitoring the progress of the each cut. Preferably, the overall dimensions of the window 10A are 2.5 inches in length and 8 inches in width. The holder 14 is preferably slightly less than 5 inches in length and 2.25 inches in width, such that it may be pressed downward into the top window 10A as necessary.

To use the first exemplary embodiment, the user selects a center plate 13 which corresponds to the thickness of the desired filet. The user then assembles the device, using the screws 12 to secure the top plate 10 and the selected center plate 13 to the bottom plate 11.

The washers 12A create a gap between the top plate 10 and the center plate 13, allowing space for the blade of the user's knife. The user inserts the piece of meat to be fileted into the window 10A, and presses it down against the bottom plate 11 with the holder 14. The user then inserts the knife blade into the gap created by the washers 12A, and cuts the filet. This process may be repeated as desired to cut multiple filets. When finished, the user may disassemble the device and safely wash the components in a standard dishwasher.

The top plate 10, the bottom plate 11, the screws 12, the center plates 13, and the holder 14 are preferably manufactured from a rigid, durable material which is dishwasher safe, corrosion resistant, and easily cleaned, such as a hard rigid plastic. Alternatively, a metal such as stainless steel or aluminum alloy has been contemplated. The washers 12A are preferably manufactured from a hard rigid plastic. Alternatively, a flexible, durable material such as rubber or silicone has also been contemplated.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A filet slicing device comprising:
a. a top plate;
b. a bottom plate;
c. a holder;
d. at least one center plate;
e. a plurality of screws;
f. said top plate being secured to said bottom plate with said plurality of screws;
g. said middle plate being secured between said bottom plate and said top plate.

2. The filet slicing device of claim 1, wherein said center plate is a plurality of center plates equal to three in number; said center plates having a thicknesses of 0.25 inches, 0.375 inches, and 0.5 inches.

3. The filet slicing device of claim 1, wherein said filet slicing device is preferably 10 inches in width and 4 inches in length.

4. The filet slicing device of claim 1, wherein the washer is the thickness of a knife to be used to slice a filet.

5. The filet slicing device of claim 1, wherein each washer is preferably 0.0625 inch in thickness.

6. The filet slicing device of claim 1, wherein the top plate provides a window; said window sized and configured to allow meat to be placed within the filet slicing device.

7. The filet slicing device of claim 6, wherein the window is 2.5 inches in length and 8 inches in width.

8. The filet slicing device of claim 1, further comprising a holder.

9. The filet slicing device of claim 8 wherein said holder is slightly less than 5 inches in length and 2.25 inches in width, such that it may be pressed downward to secure a filet.

10. The filet slicing device of claim 6, further comprising a holder.

11. The filet slicing device of claim 10 wherein said holder is slightly less than 5 inches in length and 2.25 inches in width, such that it may be pressed downward through said window to secure a filet.

12. The filet slicing device of claim 1, wherein the user selects a center plate which corresponds to the thickness of the desired filet, then assembles the device, using the screws to secure the top plate and the selected center plate to the bottom plate.

13. The filet slicing device of claim 1, wherein said filet slicing device may be disassembled and the components washed in a standard dishwasher.

14. The filet slicing device of claim 1, wherein the top plate, the bottom plate, the screws, the center plates, and the holder are manufactured from a rigid, durable material which is dishwasher safe, corrosion resistant, and easily cleaned, such as a hard rigid plastic, or a metal such as stainless steel or aluminum alloy.

15. The filet slicing device of claim 1, wherein the washers are preferably manufactured from a hard rigid plastic, or a flexible, durable material such as rubber or silicone.
